(19) United States
(12) Patent Application Publication
(10) Pub. No.: US 2008/0029138 A1
(43) Pub. Date: Feb. 7, 2008

(54) WALKING AID

(75) Inventor: Brian Foote, Blackburn (GB)

Correspondence Address: MICHAEL BEST & FRIEDRICH LLP, 100 E WISCONSIN AVENUE, Suite 3300, MILWAUKEE, WI, 53202, US

(73) Assignee: PROMEDICS LIMITED, Blackburn (GB)

(21) Appl. No.: 11/830,088

(22) Filed: Jul. 30, 2007

(30) Foreign Application Priority Data
Aug. 2, 2006 (GB) 0615405.8

(51) Int. Cl. A61H 3/00

(52) U.S. Cl. 135/67

(57) ABSTRACT

A walking aid is disclosed. The aid is generally in the form of a frame having first and second pairs of legs which are arranged to be relatively pivotable. By application of pressure to a suitable positioned handle, the aid can be made to advance forwards with minimal effort required by the user.

The present invention relates to an improved walking frame for use by those with restricted mobility, such as elderly people or those who have suffered a medical condition such as a stroke.

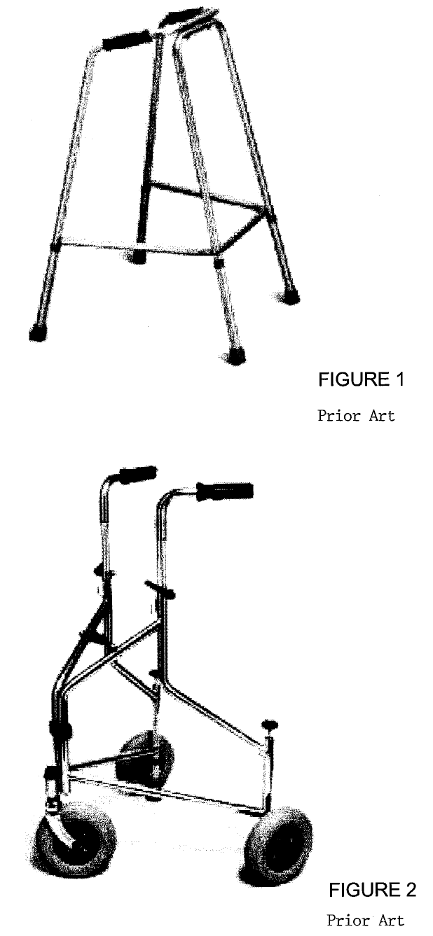

Traditional walking frames, also known colloquially as zimmer frames, consist of a rigid frame having two handles and four legs. Such prior art walking frames are mechanically simple and provide a degree of support and assistance to those who have difficulty walking. Such a prior art frame is shown in FIG. 1. In use, the user has to repeatedly lift the frame, move it forward and then step towards it, into the open area defined by three sides of the frame.

Such frames are used by a large number of people and are found to be largely satisfactory. However, for some people, the act of picking up and moving the frame is difficult and renders such frames less useful or even useless.

To remedy this problem, frames are available, which are provided with wheels so that the frame can be simply pushed forwards and does not require lifting off the ground. Such frames can be provided with three wheels (one leading and two trailing wheels), as shown in FIG. 2. Other forms, similar to the frame of FIG. 1, provided with one or more pairs of wheel, are also available.

A problem with such wheeled frames is that they can have a tendency to ‘run away’ from the user, which can cause injury or at least be very distressing. To address this, some wheeled frames are provided with brakes, but these introduce other usability problems for the user and increase the cost of the frame.

Furthermore, prior art frames tend be relatively bulky and can be difficult to transport in a car or troublesome for a user to take onto public transport.

Prior art walking aids, particularly the wheeled variety, tend to be difficult to use on steps, stairs and on wet or polished surfaces.

An aim of embodiments of the present invention is to address these and other problems with prior art walking frames, whether mentioned herein or not.

According to the present invention there is provided an apparatus as set forth in the appended claims. Preferred features of the invention will be apparent from the dependent claims, and the description which follows.

For a better understanding of the invention, and to show how embodiments of the same may be carried into effect, reference will now be made, by way of example, to the accompanying diagrammatic drawings in which:

FIG. 1 shows a prior art walking frame of a first type;

FIG. 2 shows a prior art walking frame of a second type;

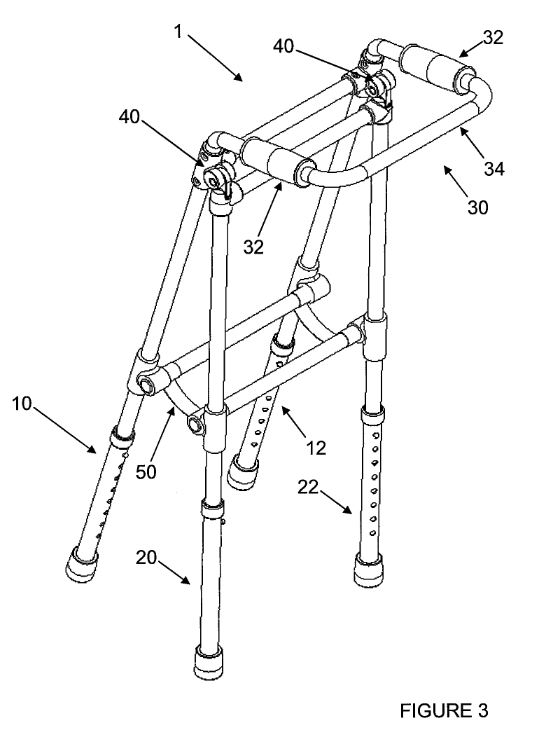

FIG. 3 shows a perspective view of a walking frame according to an embodiment of the present invention; and

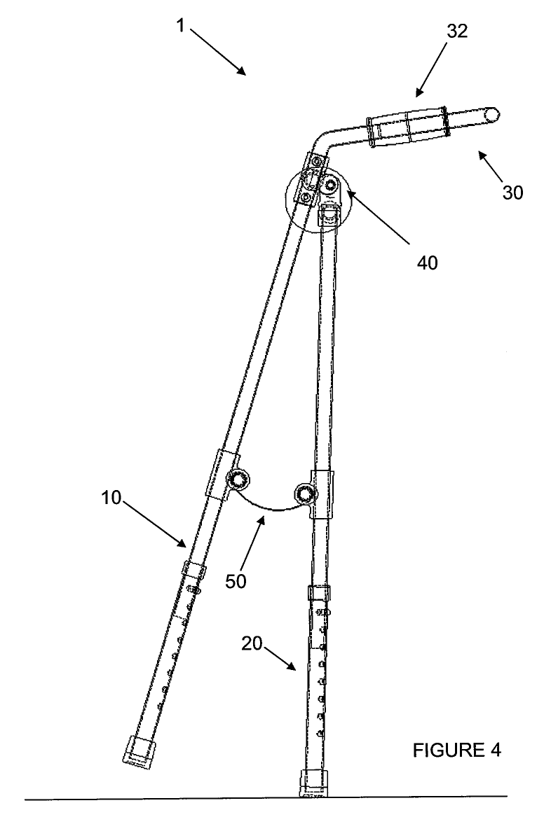

FIG. 4 shows a side view of a walking frame according to an embodiment of the present invention.

In order to address some of the problems associated with the prior art walking frames, embodiments of the present invention are arranged to be propelled forward with the minimum of effort required by the user. In normal use, the user does not need to lift the frame off the ground as it can be made to move forward using a simple rocking motion.

FIG. 3 shows a perspective view of a walking frame 1 according to an embodiment of the invention. It comprises a first pair of legs 10, 12 which are connected to a handle 30. Hingedly or rotatably connected to the first pair of legs 10, 12 is a second pair of legs 20, 22. The hinged connection 40 is made so that the second pair of legs 20, 22 are able to rotate or pivot about a point towards the upper end of the first pair of legs 10, 12 adjacent to the handle 30.

The hinged connection between first and second pairs of legs can be implemented in a number of ways including a ball and socket, a flexible joint or a strap connection.

The first and second pair of legs are connected together approximately midway along their lengths by one or more lengths of strapping or webbing material 50 which has the effect of limiting the travel between the first and second pair of legs. Alternatively, the hinge 40 may be so constructed to limit the amount of travel possible and the strap 50 may not be required.

Embodiments of the invention may be constructed from tubular aluminium, steel or a plastics material. Tubular aluminium is preferred as it offers the best combination of strength, weight and cost.

In its static position, the frame 1 will rest on both pairs of legs so that the weight of the frame is distributed evenly and borne by all four legs. The two pairs of legs occupy the positions shown in FIG. 3.

When a user wishes to use the frame, it is gripped by the handle. The user may hold onto the cushioned grips 32 at the sides of the handle 30 or may prefer to hold the portion 34 which extends between the cushioned grips 32. Whichever grip is adopted is a matter of preference only. Indeed, the aid 1 may also be used by those who have only the use of one arm and will provide considerably more stability and assurance to such a user than a walking stick.

Instead of a handle as shown in the Figures, alternative arrangements of the handle are possible. A preferred alternative effectively removes the portion 34, leaving only two separate handles 32, positioned on either side of the aid 1. The portion 34 may be provided as an optional addition which can be fastened at each end to produce the configuration shown in the Figures.

Assuming a starting position as shown in FIG. 3, the user steps forward, while holding on handle 30. By so doing, the handle is raised, the front legs 10, 12 remain in contact with the ground and rear legs 20, 22 are lifted upwards as the handle moves forward. The front legs 10, 12 remain in contact with the ground. The rear legs rotate about their hinge points due to the movement of their centre of gravity.

Eventually, the rear legs 20, 22 come to rest against the front legs 10, 12 and all four legs are now in contact with the ground.

At this point, the user presses down on the handle 30, which causes the front legs to be urged forward to the extent of their travel, as dictated by strap 50, whilst the rear legs remain in contact with the ground. Once the two pairs of legs are separated in this way, the action of the user stepping forward will cause the handle to raise and the front pair of legs to contact the ground, and continued forward motion by the user repeats the cycle already described.

In use, therefore, the aid 1 is very simple to use. Forward locomotion is obtained merely by the repeated raising and lowering of the handle 30, which causes the two pairs of legs to ‘walk’ as described.

It is also easy to see that the user never has to lift the frame off the ground, which can be of great benefit for the typical user of such a device who may have great difficulty in picking up the prior art walking frames such as that shown in FIG. 1.

Embodiments of the present invention offer a further advantage compared to the wheeled type of frame shown in FIG. 2. If a user of the prior art wheeled frame stumbles or falls, then the wheeled frame is likely to run away from them and not support them at the very time when they need its support most. Certain of the wheeled type of frames have manually operated brakes in an attempt to prevent such an occurrence, but these can not always be relied upon.

If a user of an embodiment of the present invention stumbles, even when the rear legs 20, 22 are off the ground during forward motion, the pressure of the falling user on the handle 30, tends to move the frame into its most stable configuration (as shown in FIG. 3) where it can act to support the user. This is always true as long as the weight of the user is behind the pivot point 40.

Embodiments of the invention offer several advantages over prior art walking aids. In particular, the problem of the user having to lift the entire frame off the ground to move forward is alleviated. In normal use, the frame never has to be lifted entirely off the ground as at least one pair of legs remains in contact with the ground at all times.

Furthermore, unlike prior art wheeled frames, if the user stumbles or falls while using an embodiment of the invention, the frame tends to assume its most stable configuration to support the user.

Each leg 10, 12, 20, 22 of the frame according to an embodiment of the invention may be height-adjusted in a known way. For example, the height may be adjustable in discrete steps as determined by a sprung projection which mates with one of a corresponding plurality of holes in a movable section of each leg. This is clearly seen at the lower section of each leg in FIG. 3.

When not in use, the first and second pair of legs can be stowed in close proximity to each other and, in this configuration, the frame occupies significantly less space than the previously mentioned prior art frames. This makes embodiments of the invention more convenient for daily use, particularly if the user wishes to travel by car or public transport.

Also, if travelling by air, the aid 1 can be simply and easily stowed.

To further reduce the volume occupied by the aid 1 when not in use, the handle 30 can be made to be detachable. Alternatively, the handle may be foldable so that it does not protrude when the device is stowed. In the configuration referred to previously where there is no portion 34 linking the two cushioned grips 32, then each of the handle parts 32 can be made rotatable so that they can each turn approximately 90 degrees about an axis defined by the leg 10, 12 to which they are attached. In this way, they can be made to sit flush with the frame for stowage purposes.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A walking aid comprising a handle and first and second pairs of legs wherein said second pair of legs is arranged to pivot with respect to said first pair of legs.

2. A walking aid as claimed in claim 1 wherein the pivot point is located towards an upper end of the first pair of legs, proximal the handle.

3. A walking aid as claimed in claim 1 wherein the handle comprises a pair of grips arranged to point in a direction generally opposite to the forward direction of travel.

4. A walking aid as claimed in claim 3 wherein the pair of grips further comprise a portion connecting joining their distal ends.

5. A walking aid as claimed in claim 1 wherein the first and second pair of legs are limited in the extent of their relative travel.

6. A walking aid as claimed in claim 5 wherein the extent of travel is limited by a flexible member linking the first and second pair of legs.

7. A walking aid as claimed in claim 6, wherein the flexible member is a strip of nylon webbing material.

8. A walking aid as claimed in claim 6 wherein the flexible member is positioned half-way along the length of each leg.

9. A walking aid as claimed in claim 6 wherein the extent of travel may be adjusted by altering the length of the flexible material.

10. A walking aid as claimed in claim 2 wherein the handle comprises a pair of grips arranged to point in a direction generally opposite to the forward direction of travel.

11. A walking aid as claimed in claim 10 wherein the pair of grips further comprise a portion connecting joining their distal ends.

12. A walking aid as claimed in claim 11 wherein the first and second pair of legs are limited in the extent of their relative travel.

13. A walking aid as claimed in claim 12 wherein the extent of travel is limited by a flexible member linking the first and second pair of legs.

14. A walking aid as claimed in claim 13, wherein the flexible member is a strip of nylon webbing material.

15. A walking aid as claimed in claim 14 wherein the flexible member is positioned half-way along the length of each leg.

16. A walking aid as claimed in claim 15 wherein the extent of travel may be adjusted by altering the length of the flexible material.

17. A walking aid comprising relatively movable first and second pairs of legs, wherein the walking aid is arranged to achieve forward locomotion by repeatedly:
lowering a handle, causing the first pair of legs to be propelled in the forward direction; and
raising the handle, thereby causing the second pair of legs to leave the ground and move towards the first pair of legs.
